(19) United States
(12) Patent Application Publication
(10) Pub. No.: US 2026/0275016 A1
(43) Pub. Date: Sep. 17, 2026

(54) METHODS OF SYNTHESIZING VINYLAMINE-CONTAINING POLYMER SOLUTIONS AND VINYLAMINE-CONTAINING POLYMER SOLUTIONS SYNTHESIZED THROUGH THE METHODS

(71) Applicant: SOLENIS TECHNOLOGIES, L.P., Wilmington, DE (US)

(72) Inventor: Sachin Borkar, Wilmington, DE (US)

(73) Assignee: SOLENIS TECHNOLOGIES, L.P., Wilmington, DE (US)

(21) Appl. No.: 19/561,795

(22) Filed: Mar. 10, 2026

Related U.S. Application Data
(60) Provisional application No. 63/769,880, filed on Mar. 11, 2025.

(51) Int. Cl. C08F 226/02

(52) U.S. Cl. CPC C08F 226/02

(57) ABSTRACT

Methods for producing a vinylamine-containing polymer solution, and vinylamine-containing polymer solutions produced through the methods, are provided herein. In an embodiment, a method includes polymerizing N-vinylcarboxamide monomers in a reaction mixture, hydrolyzing a resulting intermediate polymer formulation, providing a pH value associated with the reaction mixture, setting a value for one or more viscosity-affecting process parameters based on the provided pH, and implementing the value for the one or more viscosity-affecting process parameters during the reacting and/or hydrolyzing step. In an embodiment, the pH associated with the reaction mixture is changed by no more than +/−0.3 as a direct result of the implementing step.

### CROSS-REFERENCE TO RELATED APPLICATIONS

This application claims the benefit of U.S. Provisional Application No. 63/769,880, filed Mar. 11, 2025, the entire contents of which are hereby incorporated by reference.

### TECHNICAL FIELD

The present disclosure generally relates to polymer production, and more particularly relates to polymerization of N-vinylcarboxamide monomers.

### BACKGROUND

Vinylamine-containing polymers are synthetic polymers that contain vinylamine units in their chemical structure. Vinylamine-containing polymers are cationic in nature. They are also highly water soluble, which makes them suitable for use in aqueous solutions. Vinylamine-containing polymers are generally stable under a wide range of pH conditions, temperature, and exposure to oxygen. They can form films and coatings when applied to surfaces. These properties make vinylamine-containing polymers useful in various applications including papermaking, water treatment, and adhesives and coatings.

One example of a vinylamine-containing polymer is polyvinylamine (PVAm). PVAm is a polymer having a high content of primary amine functional groups. As a result, PVAm can form hydrogen and/or covalent bonds with functional surfaces or molecules, and it readily creates derivatives. PVAm adsorbs on most surfaces in water, generating cationic interfaces which can form complexes with oppositely charged polymers or molecules, including negatively charged surfactants. PVAm is very hydrophilic. Because PVAm derivatives promote adhesion between wet or dry surfaces, PVAm is used as a papermaking additive.

The general processes for synthesizing vinylamine-containing polymers are known in the industry. In one process, first, N-vinylcarboxamide monomers (e.g., vinylformamide (VFA)) are combined with a polymerization initiator in a reaction mixture to create an intermediate polymer formulation containing a poly(N-vinylcarboxamide) prepolymer (e.g., polyvinylformamide (poly-VFA) prepolymer).

After the reacting step (i.e. the polymerization reaction) is completed, acid or base is added to the resulting intermediate polymer formulation to hydrolyze the poly(N-vinylcarboxamide) prepolymer and create a polymer solution containing a vinylamine-containing polymer. The hydrolyzing step converts carboxamide functions in the poly(N-vinylcarboxamide) prepolymer into vinylamine functions.

In existing processes for synthesizing vinylamine-containing polymers, the pH of the reaction mixture is generally from about 5.0 to about 8.0, preferably from about 6.0 to about 7.0, and most typically at about 6.5. Existing processes are conducted in the recited pH range because vinylamine-containing polymer solutions are sensitive to pH and may exhibit poor dynamic viscosity and/or gelling depending upon the pH at which the processes are conducted.

The current solutions for the aforementioned problems with producing vinylamine-containing polymer solutions with acceptable characteristics (e.g. no gelling) involve adjusting or stabilizing the pH of the reaction mixture prior to the polymerization reaction by adding a buffer, acid, or caustic to the reaction mixture. However, adjusting the pH is not always desirable because pH adjusting agents may cause problems such as damage to manufacturing equipment, a need for safety measures such as personal protective equipment, and/or additional process steps. Further, maintaining the pH at a certain value may require multiple pH measurements or expensive equipment, which reduces the efficiency and increases the cost of the process.

Accordingly, it is desirable to provide processes that can offset deleterious effects, attributable to various pH conditions, on the dynamic viscosity of the resulting vinylamine-containing polymer solution. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods of synthesizing a vinylamine-containing polymer solution, and vinylamine-containing polymer solutions produced through the methods, are provided herein. In an embodiment, a method comprises reacting a polymerization initiator and one or more N-vinylcarboxamide monomers in a reaction mixture. The N-vinylcarboxamide monomers have Formula I:

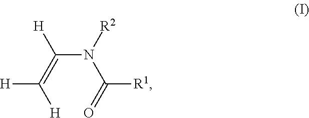

wherein R¹ and R², independently of one another, are H or C₁ to C₆ alkyl groups. Optionally, one or more vinyl monomers having a formula different from the N-vinylcarboxamide monomers may also be added to the reaction mixture. The reacting step results in an intermediate polymer formulation comprising a poly(N-vinylcarboxamide) prepolymer. The method further comprises hydrolyzing carboxamide groups in the poly(N-vinylcarboxamide) prepolymer to create a vinylamine-containing polymer solution comprising a vinylamine-containing polymer. The method further comprises providing a pH value associated with the reaction mixture. A value is set for one or more process parameters that affect dynamic viscosity of the resulting vinylamine-containing polymer solution, based on the provided pH associated with the reaction mixture. The value for the one or more process parameters is implemented during the reacting step and/or the hydrolyzing step. The pH associated with the reaction mixture is changed by no more than +/−0.3 as a direct result of the implementing step.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

The methods as provided herein enable synthesis of a vinylamine-containing polymer solution that has an acceptably low dynamic viscosity and is resistant to gelling and mixing issues. It has been found that the pH associated with the reaction mixture (i.e. the pH of the reaction mixture or the pH of a component that is combined with the monomers to form the reaction mixture) affects polymer breakdown and/or side reactions during the reacting step and/or the hydrolyzing step, leading to possible gelling and mixing issues. Specifically, at some pH values, unreacted N-vinylcarboxamide monomers tend to readily decompose into aldehydes or ketones. The aldehydes or ketones act as crosslinking agents, causing crosslinking of the polymer. Crosslinking of the polymer leads to unacceptably high dynamic viscosity and/or gelling.

Sometimes it is undesirable to adjust pH during the reacting step. Accordingly, rather than adjusting the pH associated with the reaction mixture to be within a range that minimizes the above-described undesirable effects, the methods as provided herein allow for adjustment or control of one or more process parameters that affect the dynamic viscosity of the resulting vinylamine-containing polymer solution (i.e. viscosity-affecting process parameters). In particular, values for the one or more process parameters can be set and implemented to offset the effects of any particular pH associated with the reaction mixture, while changing the pH associated with the reaction mixture by no more than about +/−0.3. The values can be set prior to reacting the components in the reaction mixture, or the reaction may begin and the values can be modified during the reaction based on pH measurements associated with the reaction mixture. When the pH associated with the reaction mixture is provided, remedial values for viscosity-affecting process parameters such as, but not limited to, initiator concentration, reaction temperature, addition of an amount of branching agent, and addition of an amount of aldehyde acceptor, can be set and implemented to minimize the presence of residual N-vinylcarboxamide monomers, decomposition of the residual monomers to form aldehydes or ketones, and crosslinking of the polymer. Thus, implementation of a value of one or more viscosity-affecting process parameters set based on a provided pH may lead to the formation of a vinylamine-containing polymer solution having an acceptable viscosity without the need to adjust or stabilize the pH through addition of a buffer, acid, or caustic.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The methods provided herein are directed to synthesis of a vinylamine-containing polymer solution. The methods involve completing one or more process steps of a known process for producing a vinylamine-containing polymer solution, including a “reacting step” and a “hydrolyzing step.” The methods first include a “reacting step,” which refers to a step of reacting a polymerization initiator with one or more N-vinylcarboxamide monomers, and optionally one or more additional vinyl monomers, in a reaction mixture to create an intermediate polymer formulation comprising a poly(N-vinylcarboxamide) prepolymer. The methods also include a “hydrolyzing step,” which refers to a step in which the poly(N-vinylcarboxamide) prepolymer contained in the intermediate polymer formulation is hydrolyzed to produce the vinylamine-containing polymer solution including vinylamine-containing polymer.

In embodiments, one or more N-vinylcarboxamide monomers is provided having the formula I:

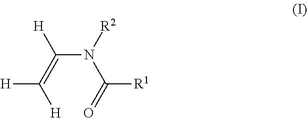

wherein R¹ and R², independently of one another, are H or C₁ to C₆ alkyl groups. The monomer(s) of formula I are combined with a polymerization initiator to form the reaction mixture under appropriate reaction conditions to effectuate a polymerization reaction.

Various N-vinylcarboxamide monomers having formula I may be employed in accordance with the present disclosure. For example, in some embodiments, if R¹ and R² are both H, then the N-vinylcarboxamide monomer of formula I is N-vinylformamide. In other embodiments, if R¹ and R² are both methyl groups, then the N-vinylcarboxamide monomer having the formula I is N-vinyl-N-methylacetamide. In still other embodiments, R¹ and R² may be two different functional groups. Other examples of N-vinylcarboxamide monomers include, but are not limited to, N-vinyl-N-methylformamide, N-vinylacetamide, N-vinyl-N-ethylacetamide, N-vinylpropionamide, N-vinyl-N-methyl-propionamide, and N-vinylbutyramide.

In some embodiments, one or more vinyl monomers of a formula different from formula I may also be reactants in the reaction mixture. “Vinyl monomer(s)” refers to monomer(s) which have an (H₂C═C—) group in their structure. Vinyl monomers could alternatively be defined as ethylenically unsaturated monomers. Examples of suitable vinyl monomers having a formula different from formula I include, but are not limited to, N-vinylpyrrolidone, acrylamide, acrylic acid, vinyl acetate, methyl acrylate, methacrylamide, N-isopropylacrylamide, N-methylmethacrylamide, acrylonitrile, vinyl chloride, styrene, methacrylic acid, vinylphosphonic acid, vinylsulfonic acid, maleic acid, itaconic acid, diallyldimethylammonium chloride (DADMAC), acrylamidopropyltrimethyl ammonium chloride (APTAC), methacrylamidopropyltrimethyl ammonium chloride, or combinations thereof. Any combination of the aforementioned monomers may be used.

The polymerization initiator may be a non-oxidizing radical initiator, such as an azo compound. Examples of azo initiators include, but are not limited to, 2,2′-azobis(2-methylpropionamidine)dihydrochloride, 2,2′-azobis(2-amidinopropane)dihydrochloride, 2,2′-azobis(N,N′-dimethyleneisobutyramidine)dihydrochloride, 2,2′-azobis[2-methyl-N-(2-hydroxyethyl)-propionamide], azo-bis-isobutyronitrile, 4,4′-azobis(4-cyanovaleric acid), 2,2′-azobis[2-(2-imidazolin-2-yl)propane]dihydrochloride, 2,2′-azobis[N-(2-carboxyethyl)-2-methylpropionamidine]tetrahydrate, or 2-2′-azobis(2-methyl-butyronitrile). In other embodiments, the polymerization initiator may be a redox catalyst. In some embodiments, the polymerization initiator may be used in an amount from about 0.01 to about 5% by weight, based on the total weight of the reaction mixture.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The reaction mixture may be an aqueous solution including at least about 30% monomers by weight based on the total weight of the reaction mixture. The concentration of the monomers in the aqueous solution may be up to about 90% by weight, alternatively from about 60% to about 85% by weight, based on the total weight of the reaction mixture. In embodiments, the reaction mixture may be buffered to a pH of from about 5 to about 8, alternatively from about 6 to about 7. To stabilize the pH during the polymerization step, the polymerization step may be carried out in the presence of a conventional buffer system. Additional components, such as process water or solvent, may also be combined with the monomers to form the reaction mixture. In embodiments, a branching agent may also be added to the reaction mixture.

In embodiments, the reacting step may be carried out under an inert gas, such as nitrogen, or under vacuum. In embodiments, the reacting step may be carried out with evaporative cooling at from 20 mbar to atmospheric pressure and a temperature in the reaction mixture of less than about 100° C., alternatively from about 25° C. to about 80° C.

In some embodiments, the reacting step may be carried out in a mixing apparatus in which the reactants can be thoroughly mixed. For example, the reacting step may be carried out in a single-screw kneader or an extruder. The solids content of the reaction mixture during the reacting step may be from about 30% to about 90% by weight, alternatively from about 60% to about 85% by weight, based on the total weight of the reaction mixture.

After the reacting step, in some embodiments, the conversion of the monomers into a polymer may be from about 75 mol % to about 100 mol %, based on the total moles of monomers present in the reaction mixture prior to polymerization. In other embodiments, the conversion of monomers into a polymer may be from about 25 mol % to about 75 mol %, based on the total moles of monomers present in the reaction mixture prior to polymerization. The lower the conversion rate of monomers into a polymer, the higher the amount of unreacted N-vinylcarboxamide monomers present in the intermediate polymer formulation.

After the reacting step has been completed, an intermediate polymer formulation has been formed. As used herein, an intermediate polymer formulation is defined as a polymer formulation which contains a poly(N-vinylcarboxamide) prepolymer. The intermediate polymer formulation may also contain other polymers, unreacted N-vinylcarboxamide monomers, residual polymerization initiator, or other byproducts or impurities. A poly(N-vinylcarboxamide) prepolymer is defined as a poly(N-vinylcarboxamide) polymer which has been formed through a reacting step but has not yet been intentionally hydrolyzed, through addition of acid or base, to form a vinylamine-containing polymer solution. The poly(N-vinylcarboxamide) prepolymer may be a homopolymer or a copolymer and may contain non-vinylcarboxamide units derived from one or more vinyl monomers of a formula different from formula I as described above. In an embodiment, the N-vinylcarboxamide monomer reacted in the reacting step is N-vinylformamide and the poly(N-vinylcarboxamide) prepolymer is a polyvinylformamide polymer. In some embodiments of the method, the poly(N-vinylcarboxamide) prepolymer has a weight average molecular weight in the range of from about 5,000 Daltons to about 5,000,000 Daltons.

As previously described, the intermediate polymer formulation containing poly(N-vinylcarboxamide) prepolymer is the intermediate product in a method of forming a vinylamine-containing polymer solution. As used herein, unreacted N-vinylcarboxamide monomers are defined as N-vinylcarboxamide monomers which were combined with a polymerization initiator in a reaction mixture, but did not react to form the poly(N-vinylcarboxamide) prepolymer, and remain as monomers in the intermediate polymer formulation. The unreacted N-vinylcarboxamide monomers may also transform into side reaction products, which may include hydrolysis products of N-vinylcarboxamide monomers, such as aldehydes or ketones.

The degree of polymerization of monomers during the reacting step is an important factor that affects properties of the resulting vinylamine-containing polymer solution. Any residual N-vinylcarboxamide monomers, or byproducts thereof, present after the reacting step may cause problems during the downstream process steps, such as a hydrolyzing step.

In embodiments, the methods further comprise adding an aldehyde acceptor to the intermediate polymer formulation before or during the hydrolyzing step (to be described below). As used herein, the term “aldehyde acceptor” refers to a compound that is capable of reacting with the reactive site of an aldehyde or ketone (i.e. quenching the aldehyde or ketone). An aldehyde acceptor may react with an aldehyde or ketone to form an adduct, binding the reactive site and preventing the aldehyde or ketone from reacting with anything else. Aldehyde acceptors may also react with residual N-vinylcarboxamide monomers. Nonlimiting examples of aldehyde acceptors include reducing compounds such as sulfite salt, bisulfite salt, sulfur dioxide, dithionite salt, hydroxylamine, or phenylhydrazine. Other examples of aldehyde acceptors include but are not limited to urea, ethyleneurea, propyleneurea, melamine, guanidine, aminoguanidine, or mixtures thereof. In embodiments, the aldehyde acceptor is a bisulfite salt such as sodium bisulfite.

In existing processes, certain pH values associated with the reaction mixture lead to a vinylamine-containing polymer solution which has an unacceptably high dynamic viscosity and which may undergo gelling. Thus, as contemplated herein and for reasons described below, a pH value associated with the reaction mixture is provided. The pH value associated with the reaction mixture may be provided before or during the reacting step. As used herein, the “pH value associated with the reaction mixture” may refer to the pH of the reaction mixture, the pH of a buffer solution added to the reaction mixture, the pH of an input to the reaction mixture such as process water or solvent, or the pH of another component that is combined with the monomers to form the reaction mixture. In embodiments, providing the pH value associated with the reaction mixture comprises measuring the pH value of the reaction mixture or of one or more of the other compositions described above. The pH value associated with the reaction mixture may be measured by colorimetric methods such as indicator solutions or pH papers, or alternatively by electrochemical methods. In an embodiment, the pH value is measured using a pH meter equipped with pH responsive electrode probes. In other embodiments, providing the pH value associated with the reaction mixture comprises calculating and/or predicting the pH value. Calculating the pH value is done using a computer processor. Predicting the pH value may be done based on prior knowledge of the process conditions and/or historical data related to the process.

In embodiments, the provided pH value associated with the reaction mixture may be from about 3.0 to about 9.0, alternatively from about 3.0 to less than 6.5, alternatively from greater than 6.5 to about 9.0, alternatively from about 3.0 to about 5.0, alternatively from about 8.0 to about 9.0. In the methods described herein, the provided pH value may be within a conventional range (generally from about 5.0 to about 8.0), or the provided pH value may be within a broader than conventional range (including above or below any target value) for vinylamine-containing polymer production, and excellent properties of the resulting vinylamine-containing polymer solution can still be achieved.

In embodiments, the method further comprises determining the pH value associated with the reaction mixture to be outside of a predetermined range. The predetermined range may be, for example, a process specification range, a range with known results, or a historical commercial operating range. In embodiments, the predetermined range may be from about 6.2 to about 6.8, alternatively from about 6.0 to about 7.0, alternatively from about 5.0 to about 8.0.

The methods provided herein also include a “hydrolyzing step,” which refers to a step in which the poly(N-vinylcarboxamide) prepolymer contained in the intermediate polymer formulation is hydrolyzed to produce the vinylamine-containing polymer solution including vinylamine-containing polymer. In some embodiments, the hydrolyzing step includes hydrolyzing the poly(N-vinylcarboxamide) prepolymer in the intermediate polymer formulation by adding one or more acids or bases to produce a vinylamine-containing polymer solution including vinylamine-containing polymer. Examples of acids which may be used for the hydrolyzing step include mineral acids or organic acids. Examples of bases which may be used for the hydrolyzing step include lithium hydroxide, sodium hydroxide, potassium hydroxide, calcium hydroxide, strontium hydroxide, and/or barium hydroxide. In some embodiments, the acid or base may be added to the reaction mixture in the hydrolyzing step in an amount of from about 0.05 to about 1.5, alternatively from about 0.4 to about 1.2, equivalents of base or acid per equivalent of formyl groups in the polymer.

As used herein, a vinylamine-containing polymer is defined as a polymer containing vinylamine functional groups, which has been formed through a reacting step and a hydrolyzing step. The vinylamine-containing polymer may be a homopolymer or a copolymer and may contain non-vinylamine units. A vinylamine-containing polymer solution is defined as a polymer formulation which contains at least a vinylamine-containing polymer. It may also contain other polymers, unreacted N-vinylcarboxamide monomers, unreacted vinyl monomers having a formula different from formula I, residual polymerization initiator, or other byproducts or impurities. Notably, residual N-vinylcarboxamide monomers or their hydrolysis products may still be present in the vinylamine-containing polymer solution.

After the hydrolyzing step has been completed, the resulting vinylamine-containing polymer may be the result of either complete hydrolysis of the poly(N-vinylcarboxamide) prepolymer or partial hydrolysis of the poly(N-vinylcarboxamide) prepolymer. In an embodiment, if complete hydrolysis has occurred, then substantially every carboxamide moiety contained in the poly(N-vinylcarboxamide) prepolymer has been hydrolyzed to form the resulting vinylamine-containing polymer. This may result in either a vinylamine homopolymer or a vinylamine copolymer containing hydrolysis products of the carboxamide moieties present in the prepolymer.

In other embodiments, complete hydrolysis may not have occurred. The degree of hydrolysis of the carboxamide moieties contained in the poly(N-vinylcarboxamide) prepolymer may be from about 0.1 mol % to less than about 99 mol %, alternatively from about 10 mol % to about 90 mol %, alternatively from about 40 mol % to about 80 mol %, alternatively from about 60 mol % to about 70 mol %, based on the total moles of carboxamide moieties in the prepolymer.

In embodiments, the vinylamine-containing polymer solution has a dynamic viscosity of no more than about 15000 cPs, alternatively no more than about 5000 cPs, alternatively from about 500 cPs to about 5000 cPs, alternatively no more than about 2500 cPs, alternatively from about 250 cPs to about 2500 cPs, alternatively from about 500 cPs to about 2500 cPs, as measured with total solids of 21%, using a Brookfield viscometer at 6 rpm using an LV spindle number 62 at 25° C. The recited dynamic viscosity values are attainable regardless of any pH associated with the reaction mixture because of the effects of the novel process steps provided herein. The processes described herein allow for synthesis of a vinylamine-containing polymer solution with an acceptable dynamic viscosity at a variety of pH values. As used herein, an “acceptable dynamic viscosity” refers to a dynamic viscosity within the above-recited ranges.

The method further comprises setting a value for one or more process parameters that affect dynamic viscosity of the resulting vinylamine-containing polymer solution (i.e. viscosity-affecting process parameters), based on the provided pH value associated with the reaction mixture. Parameters that affect dynamic viscosity may include, for example, the concentration of the polymerization initiator, an amount of branching agent added before or during the reacting step, an amount of aldehyde acceptor added before or during the hydrolyzing step, and/or the temperature of the reaction mixture.

When the pH value associated with the reaction mixture is provided, the effects of the pH value on the synthesis process and the resulting vinylamine-containing polymer solution can be predicted. Then, process parameter(s) can be set to values which offset any deleterious effects of the provided pH value on the viscosity of the resulting vinylamine-containing polymer solution. The values can be set prior to reacting the components in the reaction mixture, or the values can be modified during the reacting step and/or the hydrolyzing step (to be described below), or after the reacting step but before the hydrolyzing step. The set values are implemented during the reacting step and/or the hydrolyzing step.

At some pH values, the polymerization which occurs during the reacting step proceeds at a slower than desirable rate. This may result in some of the N-vinylcarboxamide monomers undergoing side reactions such as incidental hydrolysis, producing byproducts such as aldehydes, ketones, carboxamides, or other impurities. The byproducts are polymerization inhibitors, further slowing the polymerization reaction. Further, residual N-vinylcarboxamide monomers and/or byproducts may be present in the intermediate polymer formulation, and may undergo further side reactions to form further byproducts. The residual N-vinylcarboxamide monomers and byproducts may interfere with the hydrolyzing step, for example by causing crosslinking of the polymer, which leads to a vinylamine-containing polymer solution with an unacceptably high viscosity. The vinylamine-containing polymer solution may even exhibit gelling.

Further, at some pH values, harsh conditions may cause the poly(N-vinylcarboxamide) prepolymer to undergo degradation reactions. The degradation reactions result in an undesirable decrease in total solids percentage for the resulting intermediate polymer formulation as well as an undesirable decrease in weight average molecular weight of the poly(vinylcarboxamide) prepolymer (and thus an undesirable decrease in reduced specific viscosity (RSV) of the intermediate polymer formulation). The degradation reactions may also result in further formation of byproducts. It has been found that intermediate polymer formulations containing excessive residual monomers and/or byproducts may result in a gelled vinylamine-containing polymer solution upon hydrolysis.

In embodiments of the methods described herein, setting the value for the one or more process parameters that affect dynamic viscosity of the resulting vinylamine-containing polymer solution comprises setting a value for the concentration of the polymerization initiator. As set forth above, at certain pH values, the amount of residual N-vinylcarboxamide monomers and byproducts (e.g. aldehydes and ketones) present as a result of slow or incomplete polymerization, and/or as a result of degradation of the poly(N-vinylcarboxamide) prepolymer, is known or can be predicted. Based on the amount of residual N-vinylcarboxamide monomers and byproducts predicted to be present during the reacting step (i.e. during the polymerization reaction), the value for the concentration of the polymerization initiator can be set prior to the start of the reaction or during the reaction. When residual N-vinylcarboxamide monomers and byproducts are present during the reacting step, the monomers and byproducts may bind to some of the molecules of the polymerization initiator, reducing the amount of polymerization initiator available to initiate the polymerization reaction. Accordingly, initiator concentration can be set or modified to offset the effects of excess monomers and byproducts binding to initiator molecules during the reaction. In embodiments, the value for the concentration of the polymerization initiator may be set at from about 0.01 wt % to about 5 wt %, based on the total weight of the reaction mixture. Notably, the value for the concentration of the polymerization initiator is set based on the provided pH value associated with the reaction mixture.

In embodiments, the value for the concentration of the polymerization initiator can be set to a value which offsets the effects of polymer degradation based on pH associated with the reaction mixture. A higher concentration of polymerization initiator generally leads to a poly(N-vinylcarboxamide) prepolymer having a lower weight average molecular weight, which may lead to a vinylamine-containing polymer solution having a higher occurrence of gelling. Thus, based on the provided pH, polymer degradation can be predicted, and the value for the concentration of the polymerization initiator can be set to achieve a desired weight average molecular weight at the given pH associated with the reaction mixture. Regardless of the pH value associated with the reaction mixture, setting the value for the concentration of the polymerization initiator based on the provided pH may allow for production of a vinylamine-containing polymer solution with an acceptable viscosity.

In embodiments, the step of setting a value for the one or more process parameters that affect dynamic viscosity of the resulting vinylamine-containing polymer solution comprises setting a value for an amount of the aldehyde acceptor. At certain pH values, the amount of residual N-vinylcarboxamide monomers and byproducts (e.g. aldehydes and ketones) present as a result of slow or incomplete polymerization, and/or as a result of degradation of the poly(N-vinylcarboxamide) prepolymer, is known or can be predicted. Based on the amount of residual N-vinylcarboxamide monomers and byproducts in the intermediate polymer formulation, an amount of aldehyde acceptor can be determined to account for the residual N-vinylcarboxamide monomers and byproducts. In embodiments, unreacted N-vinylcarboxamide monomers and byproducts are present during the hydrolyzing step, and the value for the amount of aldehyde acceptor can be set or modified after the hydrolyzing step has begun based on pH associated with the reaction mixture. Quenching residual monomers minimizes breakdown of monomers to form additional byproducts. Quenching byproducts minimizes crosslinking of the polymer, thus minimizing the likelihood of gelling or unacceptably high viscosity of the vinylamine-containing polymer after the hydrolyzing step. Thus, regardless of the value of the pH associated with the reaction mixture, setting the value for the amount of aldehyde acceptor to be added based on the provided pH allows for production of a vinylamine-containing polymer solution with an acceptable viscosity.

In embodiments, the amount of the aldehyde acceptor may be set at from about 0.01 wt % to about 10 wt %, alternatively from about 0.5 wt % to about 5 wt %, relative to the total weight of the vinyl monomers in the reaction mixture. Notably, the value for the amount of the aldehyde acceptor is set based on the provided pH value associated with the reaction mixture.

In embodiments, setting the value for the one or more process parameters that affect dynamic viscosity of the resulting vinylamine-containing polymer solution comprises setting a value for the temperature of the reaction mixture during the reacting step. The value for the temperature of the reaction mixture may be set prior to the start of the reaction based on the provided pH, or the value for the temperature of the reaction mixture may be set or modified at any point during the reacting step.

As described above, at certain pH values, degradation of the polymer may occur, and/or excessive residual N-vinylcarboxamide monomers or byproducts may be present. Generally, higher temperatures contribute to degradation of the polymer and formation of byproducts, so if the provided pH value is known to cause degradation, then the value for the temperature of the reaction mixture may be decreased to offset the effects of the pH value. If the pH value is known to cause slow polymerization and thus excessive residual monomers and byproducts, then the value for the temperature of the reaction mixture may be increased to speed up polymerization and minimize the amount of residual monomers or byproducts. The value of the temperature of the reaction mixture may also be increased or decreased, based on the provided pH, to affect the weight average molecular weight of the poly(N-vinylcarboxamide) prepolymer. Thus, regardless of the value of the pH associated with the reaction mixture, setting the value for the temperature of the reaction mixture based on the provided pH allows for production of a vinylamine-containing polymer solution with an acceptable viscosity.

In embodiments, the value for the temperature of the reaction mixture may be set to a value of less than about 100° C., alternatively from about 25° C. to about 80° C. In embodiments, the value for the temperature of the reaction mixture may be set to a value of from about 20° C. to about 100° C., alternatively from about 40° C. to about 70° C. Notably, the value for the temperature of the reaction mixture is set based on the provided pH value associated with the reaction mixture.

In embodiments, the pH associated with the reaction mixture is changed by no more than +/−0.3, alternatively no more than +/−0.1, alternatively no more than +/−0.01, as a direct result of the implementing step. The limit on the change in the pH associated with the reaction mixture as a direct result of the implementing step indicates that implementing the set value for the one or more viscosity-affecting process parameters may cause an incidental change in pH. Accordingly, the implementation of the set value for the one or more process parameters affects the viscosity of the resulting vinylamine-containing polymer solution without significantly affecting the pH associated with the reaction mixture, and an acceptable viscosity of the vinylamine-containing polymer can be achieved at a variety of pH values.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

### EXAMPLES

### Example 1

To 279.74 grams of deionized water was added 1.11 grams of 75 wt % aqueous phosphoric acid and 1.38 grams of 25 wt % aqueous sodium hydroxide, to form a buffer solution. Additional phosphoric acid and/or sodium hydroxide was added if needed until the pH of the solution was in the range of 6.5+/−0.3, as measured using a pH meter equipped with pH responsive electrode probes. The solution was divided into four batches. For Batch 1, additional phosphoric acid was added until the pH of the solution was in the range of 3.0+/−0.3. For Batch 2, additional phosphoric acid was added until the pH of the solution was in the range of 5.0+/−0.3. For Batch 3, no additional steps were taken. For Batch 4, additional sodium hydroxide was added until the pH of the solution was in the range of 9.0+/−0.3. Then, each batch of the solution was charged to a kettle and heated, while stirring at 250 RPM, until the temperature of each solution reached 80° C. Then, the pressure was slowly lowered to about 320 torr. When the pressure reached 320 torr, the kettle contents were boiling and the temperature had dropped to 78° C.

To each kettle was added 78.9 grams of N-vinylformamide (VFA) over a period of 90 minutes, and simultaneously 12.5 grams of 3 wt % V-50 initiator solution over a period of 170 minutes. After the VFA addition was complete, 10 grams of boiled (deaerated) deionized water was used to rinse the VFA line that was used to add the VFA, to prevent slow leaching of VFA into the polymerization reaction mixture due to water condensing in the line and dripping back into the reaction mixture.

The temperature of the reaction mixture was maintained at a temperature range of from 78° C. to 79.5° C. by increasing or decreasing the pressure. After 170 minutes from the start of the reaction, the kettle contents were heated to 80° C. by decreasing the pressure to about 350 torr (with a circulator temperature in the range of from 86° C. to 92° C. After 260 minutes from the start of the reaction, 3.6 grams of 3 wt % V-50 initiator solution was added over a period of 5 minutes, and the reaction was continued for an additional 60 minutes. After 320 minutes from the start of the reaction, the vacuum was released, and an aliquot of the intermediate polymer formulation (containing the polyvinylformamide prepolymer) was removed for analysis.

Then, 2.42 grams of a 38 wt % aqueous solution of sodium bisulfite was added to the intermediate polymer formulation and allowed to stir for five minutes. Hydrolysis was performed by adding 1.05 molar equivalents, based on the total moles of polyvinylformamide prepolymer present in the intermediate polymer formulation, of 25 wt % sodium hydroxide solution and allowing the hydrolysis reaction to continue for 3 hours with the reactants at a temperature of 80° C. The resulting polyvinylamine polymer solution was analyzed. The results are shown in Table 1 below.

TABLE 1
Characteristics of Intermediate Polymer Formulation and Polyvinylamine
Polymer Solution Produced at Various pH Values

| | | | Reduced | Residual | | | |
|---|---|---|---|---|---|---|---|
| | | Percent | Specific | VFA | Weight | Number | |
| | | Total Solids | Viscosity of | Monomers in | Average | Average | Appearance |
| | pH of | of | Intermediate | Intermediate | Molecular | Molecular | of Polymer |
| | Buffer | Intermediate | Polymer | Polymer | Weight of | Weight of | Solution |
| | Solution | Polymer | Formulation | Formulation | Prepolymer | Prepolymer | After |
| Batch | (+/−0.3) | Formulation | (dL/g) | (ppm) | (Daltons) | (Daltons) | Hydrolysis |
| 1 | 3 | 19.84 | 1.505 | 81 | 207000 | 161000 | Brown; Gel |
| 2 | 5 | 21.62 | 2.176 | 48 | 313000 | 234000 | Pale Yellow; |
| | | | | | | | Liquid |
| 3 | 6.5 | 21.75 | 2.029 | 58 | 274000 | 209000 | Pale Yellow; |
| | | | | | | | Liquid |
| 4 | 9 | 20.62 | 1.705 | 10958 | 233000 | 162000 | Brown; Gel |

The percent total solids of the intermediate polymer formulation was measured by thermogravimetric moisture analysis. The targeted percent total solids for all trials was 22%. The reduced specific viscosity (RSV) of the intermediate polymer formulation was measured in accordance with ASTM D446. The flow time of a 0.25 wt % solution of the intermediate polymer formulation in 1M NH₄Cl was measured at a temperature of 25° C. using a Ubbelohde type viscometer and a Brinkmann Viscometer C. The flow time of pure 1M NH₄Cl was measured by the same method. The relative viscosity was calculated based on the measured flow times. Then, the reduced specific viscosity was calculated based on the relative viscosity. The amount of residual VFA monomers in the intermediate polymer formulation was measured using liquid chromatography. The weight average molecular weight and number average molecular weight of the intermediate polymer formulation was measured using size-exclusion chromatography (SEC). The appearance of the polyvinylamine polymer solution was determined by visual observation.

The results of this Example demonstrate that intermediate polyvinylformamide polymer formulations produced with a pH value associated with the reaction mixture of 5 and 6.5 achieved a percent total solids closer to the target of 22% than intermediate polyvinylformamide polymer formulations produced with a pH value associated with the reaction mixture of 3 and 9. The results also show that the formulations produced with pH values of 5 and 6.5 achieved a higher RSV than formulations produced with pH values of 3 and 9. The formulation produced with a pH value of 3 had a slightly higher amount of residual VFA than the formulations produced with pH values of 5 and 6.5, and the formulation produced with a pH value of 9 had a significantly higher amount of residual VFA than any of the other formulations. The formulations produced with pH values of 5 and 6.5 achieved higher molecular weights (both weight average and number average) than formulations produced with pH values of 3 and 9. Further, the resulting polyvinylamine polymer solutions produced with pH values of 5 and 6.5 had a lighter color than the polyvinylamine polymer solutions produced with pH values of 3 and 9, which also exhibited gel formation 10 minutes after the completion of hydrolysis.

Based on the differences in percent total solids of the intermediate polymer formulation, reduced specific viscosity of the intermediate polymer formulation, residual VFA monomers present in the intermediate polymer formulation, weight average and number average molecular weight of the polyvinylformamide prepolymer, and appearance of the polyvinylamine polymer solution after hydrolysis (i.e. color and occurrence of gelling), measures may be taken as described herein to control the aforementioned variables and minimize the effect of pH on the viscosity of the polyvinylamine polymer solution.

What is claimed is:

1. A method of synthesizing a vinylamine-containing polymer solution, the method comprising the steps of:
reacting a polymerization initiator, one or more N-vinylcarboxamide monomers, and optionally one or more additional vinyl monomers having a formula different from the N-vinylcarboxamide monomers, in a reaction mixture to create an intermediate polymer formulation comprising a poly(N-vinylcarboxamide) prepolymer, wherein the N-vinylcarboxamide monomers have the general formula I 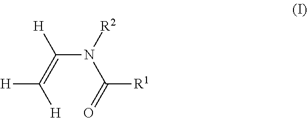
wherein R¹ and R², independently of one another, are H or C₁ to C₆ alkyl groups;
hydrolyzing carboxamide groups in the poly(N-vinylcarboxamide) prepolymer to create a vinylamine-containing polymer solution comprising a vinylamine-containing polymer;
providing a pH value associated with the reaction mixture;
setting a value for one or more process parameters that affect dynamic viscosity of the resulting vinylamine-containing polymer solution, based on the provided pH associated with the reaction mixture; and
implementing the value for the one or more process parameters during the reacting step and/or the hydrolyzing step, wherein the pH associated with the reaction mixture is changed by no more than +/−0.3 as a direct result of the implementing step.

2. The method of claim 1, wherein providing the pH value associated with the reaction mixture comprises measuring the pH value associated with the reaction mixture.

3. The method of claim 1, wherein providing the pH value associated with the reaction mixture comprises calculating the pH value associated with the reaction mixture with a computer processor and/or predicting the pH value associated with the reaction mixture based on prior knowledge and/or historical data.

4. The method of claim 1, further comprising determining the pH value associated with the reaction mixture to be outside of a predetermined range.

5. The method of claim 4, wherein the predetermined pH range is from about 6.0 to about 7.0, and wherein the pH value associated with the reaction mixture is determined to be outside of the predetermined range of from about 6.0 to about 7.0.

6. The method of claim 4, wherein the predetermined pH range is from about 5.0 to about 8.0, and wherein the pH value associated with the reaction mixture is determined to be outside of the predetermined range of from about 5.0 to about 8.0.

7. The method of claim 1, wherein providing the pH value associated with the reaction mixture comprises providing the pH value associated with the reaction mixture of from about 3.0 to less than 6.5.

8. The method of claim 1, wherein providing the pH value associated with the reaction mixture comprises providing the pH value associated with the reaction mixture of from greater than 6.5 to about 9.0.

9. The method of claim 1, wherein setting the value for the one or more process parameters that affect dynamic viscosity of the resulting vinylamine-containing polymer solution comprises setting a value for the concentration of the polymerization initiator.

10. The method of claim 1, further comprising adding an aldehyde acceptor before or during the hydrolyzing step, and wherein setting the value for the one or more process parameters that affect dynamic viscosity of the resulting vinylamine-containing polymer solution comprises setting a value for the amount of the aldehyde acceptor.

11. The method of claim 1, wherein setting the value for the one or more process parameters that affect dynamic viscosity of the resulting vinylamine-containing polymer solution comprises setting a value for the temperature of the reaction mixture.

12. The method of claim 1, wherein the resulting vinylamine-containing polymer solution has a dynamic viscosity of no more than about 5000 cPs, as measured with total solids of 21%, using a Brookfield viscometer at 6 rpm using an LV spindle number 62 at 25° C.

13. The method of claim 1, wherein the set value for the one or more process parameters that affect the dynamic viscosity of the resulting vinylamine-containing polymer solution is implemented during the reacting step.

14. A vinylamine-containing polymer solution formed by:
reacting a polymerization initiator, one or more N-vinylcarboxamide monomers, and optionally one or more additional vinyl monomers having a formula different from the N-vinylcarboxamide monomers, in a reaction mixture to create an intermediate polymer formulation comprising a poly(N-vinylcarboxamide) prepolymer, wherein the N-vinylcarboxamide monomers have the general formula I;
hydrolyzing carboxamide groups in the poly(N-vinylcarboxamide) prepolymer to create a vinylamine-containing polymer solution comprising a vinylamine-containing polymer;
providing a pH value associated with the reaction mixture;
setting a value for one or more process parameters that affect viscosity of the resulting vinylamine-containing polymer solution, based on the provided pH associated with the reaction mixture; and
implementing the value for the one or more process parameters during the reacting step and/or the hydrolyzing step, wherein the pH associated with the reaction mixture is changed by no more than +/−0.3 as a result of the implementing step.
